(19) United States
(12) Patent Application Publication
(10) Pub. No.: US 2003/0187919 A1
(43) Pub. Date: Oct. 2, 2003

(54) Digest automatic generation method and system

(75) Inventors: Haruo Nakamura, Kawasaki (JP); Kazumasa Kuroshita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/288,485

(22) Filed: Nov. 6, 2002

(30) Foreign Application Priority Data
Aug. 20, 2002 (JP) 2002-238839
Mar. 29, 2002 (JP) 2002-096631

(51) Int. Cl. G06F 15/16

(52) U.S. Cl. 709/203

(57) ABSTRACT

This invention is a technique for automatically generating a suitable digest of the content, which can attract the interest of many viewers. This invention comprises the steps of: acquiring user instruction information associated with a specific content, such as information concerning a re-viewing desired range designated by the user and information concerning a delivery request for the specific content, from a user terminal that is a delivery designation; and generating a digest of the specific content based on at least the user instruction information. Moreover, this invention may further comprise a step of acquiring information concerning a scene change of the specific content, and in the digest generating step, the digest may be generated based on the information concerning the scene change and the information concerning the delivery request of the specific content. This is because the digest is made not to start from a halfway place in the middle of the scene.

### TECHNICAL FIELD OF THE INVENTION

The present invention relates to a technique for automatically generating a digest of a content to be delivered through a network.

### BACKGROUND OF THE INVENTION

By the recent development of the Internet, various kinds of contents such as video and audio have been delivered through the Internet. However, since the content to be delivered ranges over enormous kinds, it is difficult to judge which content is content desired by a viewer, from only its title. Accordingly, there are many cases where a digest of each content is generated, and such a digest is provided to a viewer as the need arises. When the digest is generated, it has been necessary for a producer or an editor of the content to extract scenes from the content, which are likely to attract the viewer's interest.

Incidentally, for example, Japanese Patent Laid-Open No. 2001-103404 discloses following matters. That is, there are provided an information center capable of generating audience rating information of a broadcast program, and a recording device including means suitably connected to the information center to obtain the audience rating information, and the recording device includes means for previously setting an audience rating, and means for automatically recording a broadcast program with an audience rating equal to or higher than the set audience rating by comparing the set audience rating with the audience rating information obtained from the information center. In this publication, any consideration is not given to a digest.

As stated above, there is a problem that if the content is manually edited to generate a digest, it takes much time for the producer or the editor to specify the scenes to be included in the digest. Besides, there is also a case where the producer or the editor has to generate plural digests for different line speeds, and it takes a great deal of labor to perform manual editing of the digest.

Besides, in the case where the digest is manually generated, since the scene to be included in the digest is greatly affected by the subjectivity of the producer or the editor, there is a problem that scenes desired by viewers are not necessarily covered.

### SUMMARY OF THE INVENTION

Accordingly, the present invention has been made to solve the problems of the background art and an object thereof is to provide a technique for automatically generating a suitable digest of the content, which can attract the interest of many viewers.

According to a first aspect of the invention, a digest automatic generation method for automatically generating a digest of a content to be delivered to a user terminal from a server comprises the steps of: acquiring user instruction information associated with a specific content from the user terminal that is a delivery destination of the specific content; and generating a digest of the specific content on the basis of at least the user instruction information.

As stated above, since the method is based on the user instruction information relating to the specific content that is a digest generation object, it becomes possible to generate the digest, which can attract the interest of many viewers.

There is also a case where the aforementioned user instruction information is, for example, information concerning a re-viewing desired range indicated by a user of the user terminal. As stated above, when the suitable range for the digest is directly indicated by the user, it becomes possible to generate the digest, which can attract the interest of many viewers.

On the other hand, there is also a case where the aforementioned user instruction information is information concerning a delivery request for the specific content. That is, at the time of delivery of the specific content, the user terminal transmits a delivery instruction such as reproduction, rewinding, fast-forward, or stop to a delivery server, and if the delivery instruction is used, a portion attracting the interest of more people can be specified, and it becomes possible to generate a suitable digest.

Besides, the first aspect of the invention may further comprise a step of acquiring information concerning a scene change of the specific content, and in the aforementioned digest generating step, on the basis of the information concerning the scene change and the information concerning the delivery request for the specific content, the digest of the specific content is generated. This is because for example, if a range constituting the digest is simply determined only by the information concerning the delivery request from the user, the digest may start from a halfway place in the middle of the scene.

There is also a case where the information concerning the scene change of the specific content is, for example, information indicating a change degree of an amount of data delivered in a predetermined period. This is because in the case of streaming delivery, if there is a scene change (changeover), the amount of delivered data is abruptly increased.

Besides, in the aforementioned digest generating step, a noticeable range of the specific content in a predetermined delivery state may be specified by using the information concerning the delivery request for the specific content, and the specified noticeable range of the specific content may be changed by using the information concerning the scene change of the specific content.

Further, the aforementioned digest generating step may comprise the steps of: specifying a start point of the noticeable range of the specific content in a first delivery state by using the information concerning the delivery request of the specific content; changing the specified start point of the noticeable range of the specific content by using the information concerning the scene change of the specific content; and specifying an end point of the noticeable range of the specific content in a second delivery state by using the information concerning the delivery request for the specific content.

Besides, there is also a case where the aforementioned digest generating step further comprises a step of correcting the noticeable range of the specific content on the basis of a pre-set limitation concerning a reproduction time of the digest or an amount of data. This is for preventing the reproduction time of the digest from excessively elongating or the amount of delivery data from excessively increasing. For example, a threshold value of the aforementioned predetermined delivery state or threshold values of the first and second delivery states have only to be changed.

A digest automatic generation method according to a second aspect of the invention comprises the steps of: acquiring information concerning a delivery state of a specific content to a user terminal and information concerning characteristics of the specific content, and storing them in a storage device; and generating a digest of the specific content on the basis of the information concerning the delivery state of the specific content and the information concerning the characteristics of the specific content, and storing it in the storage device. A portion attracting the interest of many viewers is specified by the information concerning the delivery state, and the specified portion is adjusted by the information concerning the characteristics of the specific content.

Incidentally, there is also a case where the information concerning the characteristics of the specific content includes information indicating a change degree of brightness or color saturation between predetermined frames. This is because for example, in the case where the change of brightness or color saturation is large, there is a high possibility that the changeover of scenes occurs.

Incidentally, the digest automatic generation method of the invention can be carried out by a program and a computer, and this program is stored in a storage medium or a storage device, for example, a flexible disk, a CD-ROM, a magneto-optical disk, a semiconductor memory, or a hard disk. Besides, there is also a case in which it is distributed as a digital signal through a network or the like. Incidentally, intermediate processing results are temporarily stored in a memory.

### BRIEF DESCRIPTION OF THE DRAWINGS

FIG. 1 is a system outline diagram according to a first embodiment of the invention;

FIGS. 2A and 2B are diagrams showing an example of a frame table and an accumulated frame table;

FIGS. 3A to 3D are conceptual explanatory diagrams of digest generation;

FIG. 4 is a diagram showing a processing flow of generating the rough video content;

FIG. 5 is a diagram showing a main processing flow from the delivery of the video content to the generation of digest video data;

FIG. 6 is a diagram showing a processing flow of generating the digest video data;

FIG. 7 is a system outline diagram according to a second embodiment of the invention;

FIG. 8 is a diagram showing an example of a log data table;

FIG. 9A is a diagram showing an access state;

FIG. 9B is a diagram showing a time change of the number of accesses;

FIG. 10 is a diagram showing a main processing flow according to the second embodiment of the invention;

FIG. 11 is a diagram showing an example of a stream data table;

FIG. 12 is a diagram showing an example of a differential data amount table;

FIG. 13A is a diagram showing a first example of a time management table;

FIG. 13B is a diagram showing a second example of the time management table;

FIG. 14 is a diagram showing a first portion of a processing flow of a time management table generation processing;

FIG. 15 is a diagram showing a second portion of a processing flow of the time management table generation processing; and

FIG. 16 is a diagram showing a second example of the differential data amount table.

### DETAIL DESCRIPTION OF THE PREFERRED EMBODIMENTS

1. First Embodiment

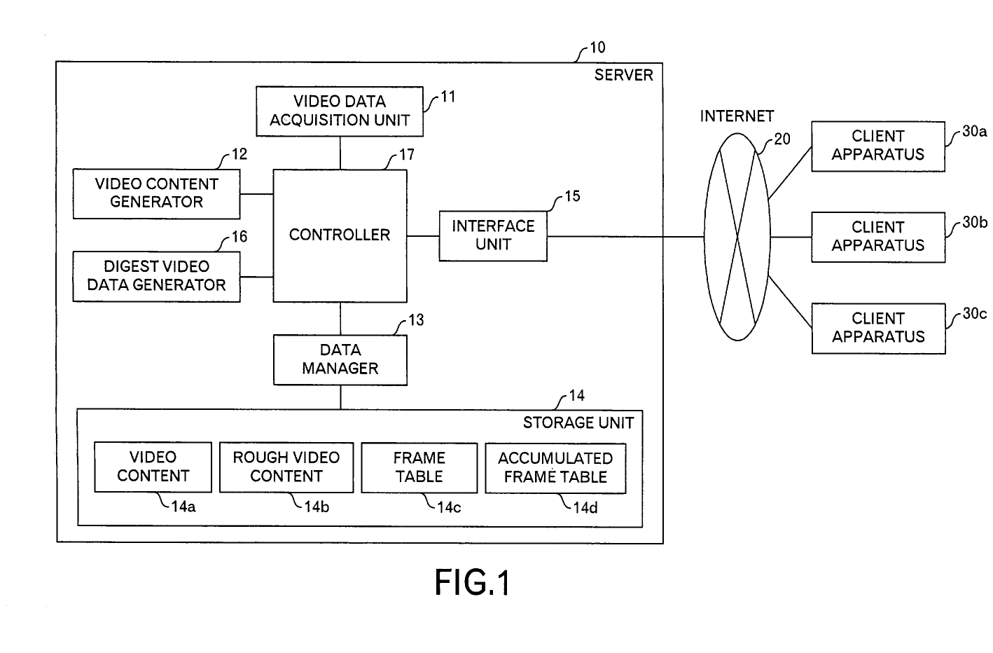

FIG. 1 is a diagram showing a system structure of a digest automatic generation system according to a first embodiment of the invention. As shown in the drawing, this digest automatic generation system includes a server 10 for delivering video contents through the Internet 20 in video on demand (VOD), and plural client apparatuses 30a to 30c used by users as viewers.

The digest automatic generation system shown in the drawing is characterized in that a digest of the video content is automatically generated with the cooperation of the users (viewers) of the respective client apparatuses 30a to 30c. Specifically, in this digest automatic generation system, the server 10 collects, as a frame table, information relating to re-viewing desired portions of the video content from the users of the client apparatuses 30a to 30c who viewed the video content, and automatically generates a digest of the video content on the basis of the collected frame table.

As shown in the drawing, this server 10 includes a video data acquisition unit 11, a video content generator 12, a data manager 13, a storage unit 14, an interface unit 15, a digest video data generator 16, and a controller 17.

The video data acquisition unit 11 is an acquisition unit for acquiring video data as a delivery object, and specifically, acquires analog video data or digital video data from a video camera connected through cable, reads video data from a DVD (Digital Versatile Disk) to acquire digital video data, or acquires digital video data through the Internet 20.

The video content generator 12 encodes the analog video data or the digital video data acquired by the video data acquisition unit 11 to prepare a video content 14a for delivery, and prepares a rough video content 14b with picture quality lower than the video content.

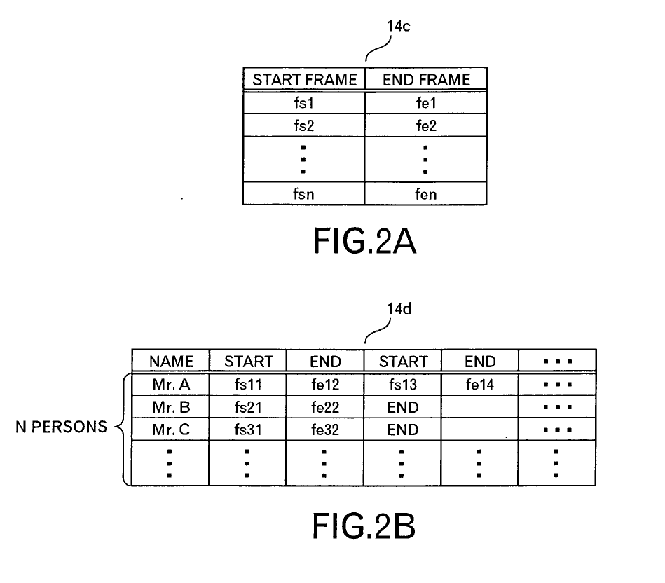

The data manager 13 is a management unit for storing the video content 14a and the rough video content 14b generated by the video content generator 12, a frame table 14c, and an accumulated frame table 14d into the storage unit 14 and managing them. Here, this frame table 14c is a table in which frame numbers of re-viewing desired portions received from the respective client apparatuses 30a to 30c are written, and as shown in FIG. 2A, plural pairs of start frames and end frames are stored. Besides, the accumulated frame table 14d is such that the frame tables 14c acquired from the respective client apparatuses 30a to 30c are united into one table, and as shown in FIG. 2B, the contents of the frame table of Mr. A, the contents of the frame table of Mr. B, and the contents of the frame table of Mr. C are collectively written.

The storage unit 14 is a storage device such as a hard disk drive, and as already described, it stores the video content 14a, the rough video content 14b, the frame table 14c, the accumulated frame table 14d and the like. The interface unit 15 is an interface unit for transmitting and receiving data by the HTTP (Hyper Text Transfer Protocol) protocol to and from the client apparatuses 30a to 30c through the Internet 20.

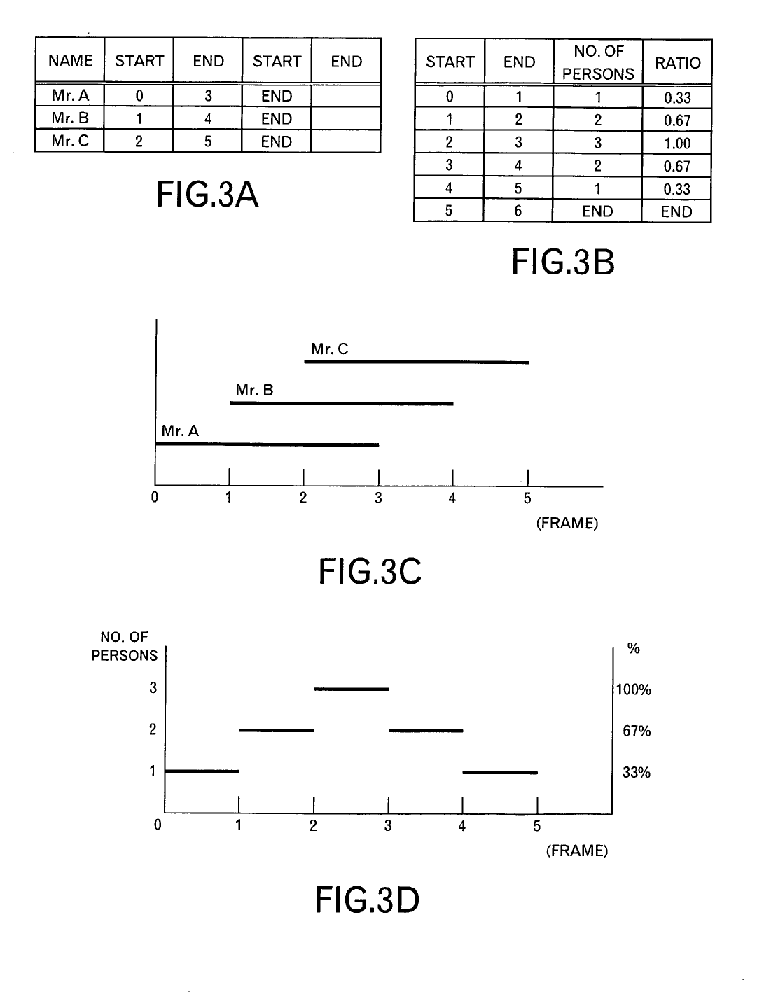

The digest video data generator 16 is a processing unit for generating digest video content data as a digest of the video content on the basis of the accumulated frame table 14d stored in the storage unit 14. FIGS. 3A to 3D are explanatory diagrams for explaining the generation concept of the digest video data of the digest video data generator 16. When Mr. A using the client apparatus 30a selects 0th to third frames, Mr. B using the client apparatus 30b selects first to fourth frames, and Mr. C using the client apparatus 30c selects second to fifth frames, the accumulated frame table 14d shown in FIG. 3A is obtained. Then, when the contents of the accumulated frame table 14d are illustrated while the horizontal axis is made to indicate the frame, the result shown in FIG. 3C is obtained. Besides, when a re-viewing desired ratio is calculated by using the accumulated frame table 14d, a ratio table shown in FIG. 3B is obtained, and when the result is illustrated with the vertical axis as the ratio and the horizontal axis as the frame, the result of FIG. 3D is obtained.

Then, the digest video data generator 16 selects the second to third frame with the highest ratio (all three persons select), and next selects the first to second frame and the third to fourth frame, which are the second highest ratio, as the digest frames. As stated above, frames are sequentially selected from one having a higher ratio, and the frames are sequentially selected while the ratio is lowered, until they reach a digest viewing time previously determined as a viewing time of the digest. For example, in the case where although the total time of the frames 1 to 4 having a ratio of not less than 67% falls within the digest viewing time, the total time exceeds the digest viewing time when the frame 0 to 1 and the frame 4 to 5 having a ratio of 33% are added, the frames 1 to 4 are selected as the frames of the digest.

The client apparatuses 30a to 30c are, for example, personal computers each of which includes a Web browser for accessing many Web sites existing in the Internet, downloading texts, still pictures, video content and the like, and displaying them on a display device, a player for receiving the video content and audio content from many streaming delivery servers existing in the Internet and displaying them on the display device, a display, a keyboard, a mouse, a communication function, and the like. The Web browser mainly downloads the image content or the like, and then displays it on the display device, and the player receives data delivered by streaming technology and displays it.

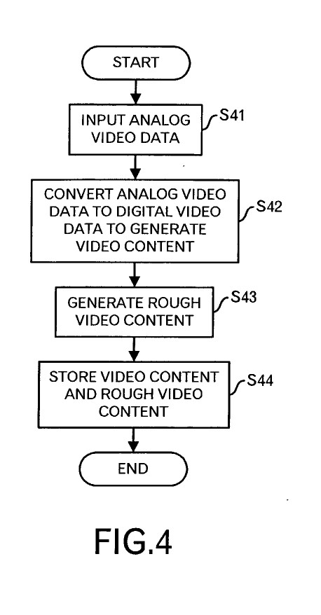

Next, a processing flow of generating the video content by the video content generator 12 shown in FIG. 1 will be described by the use of FIG. 4. Incidentally, for convenience of explanation, a case where the analog video data is acquired by the video data acquisition unit 11 will be described.

As shown in FIG. 4, when the video data acquisition unit 11 acquires the analog video data (step S41), the video content generator 12 converts the analog video data into the digital video data, performs encoding including a compression processing if necessary, and generates the video content 14a (step S42).

Besides, this video content generator 12 generates the rough video content 14b for frame selection, having picture quality lower than the video content 14a to be transmitted to the client apparatuses 30a to 30c for video viewing (step S43), and outputs the generated rough video content 14b, together with the video content 14a, to the data manager 13. The data manager 13 receiving the data makes the rough video content 14b and the video content 14a correspond to each other and stores them in the storage unit 14 (step S44).

By performing such processing, the video content 14a to be delivered and the rough video content 14b used for frame selection can be generated and stored in the storage unit 14. Incidentally, here, although omitted for convenience of explanation, in the case where video content is delivered live, the delivery and storage of the generated video content 14a has only to be processed in parallel.

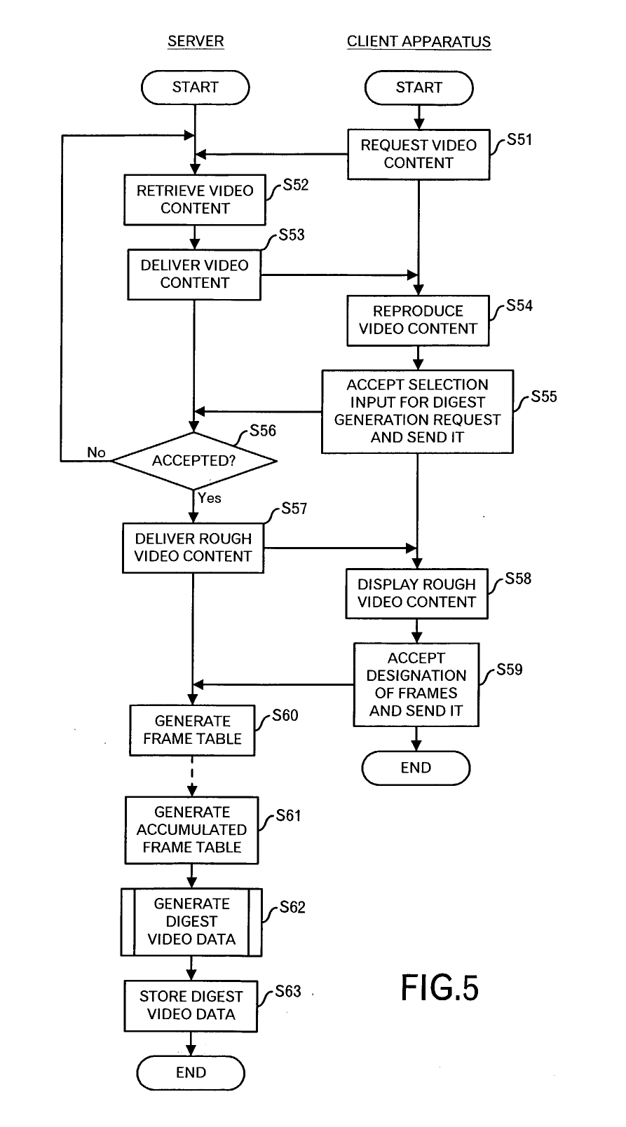

Next, a processing flow of a series of processings to generate the digest video data through data transmission and reception between the server 10 and the client apparatus 30a shown in FIG. 1 will be described by the use of FIG. 5. Incidentally, here, a case is described in which the video content is delivered in video on demand.

As shown in FIG. 5, when the client apparatus 30a requests a video content for the server 10 (step S51), in the server 10, the data manager 13 retrieves the video content 14a from the storage unit 14 in response to the request (step S52), and the interface unit 15 delivers the read video content 14a to the client apparatus 30a as a requester (step S53). The client apparatus 30a receiving this delivery reproduces the video content 14a on the display screen (step S54). The user of the client apparatus 30a views the video displayed on the display screen.

Then, when completing the reproduction of the video content, the client apparatus 30a displays a menu for requesting the digest generation on the display screen, and requests the user of the client apparatus 30a to cooperate on the generation of a digest. Incidentally, although the detailed description is omitted, for example, there is also a case where a delivery fee of the video content for the user cooperating on the generation of the digest is lowered.

As a result, in the case where the user of the client apparatus 30a has performed a selection input to accept the request of the digest generation, or a selection input to reject it, the client apparatus 30a receives the selection input of the user, and transmits data of the selection input to the server 10 (step S55). The interface unit 15 of the server 10 receives the data concerning the selection input of the user from the client apparatus 30a, and temporarily stores the data in the storage device. Then, the controller 17 judges whether the selection input indicates the acceptance of the request of the digest generation on the basis of the received data (step S56). In case the rejection is indicated, the processing is returned to the first for the processing of a next user. On the other hand, in case the acceptance is indicated, the data manager 13 searches the storage unit 14 to read out the corresponding rough video content 14b, and delivers it from the interface unit 15 to the client apparatus 30a (step S57). Incidentally, the reason why the rough video content 14b, not the normal video content 14a, is delivered is that one with low picture quality is sufficient to select scenes of the digest. As the rough video content 14b, one in which audio is removed, or still pictures representing respective scenes may be used.

Then, when receiving the rough video content 14b from the sever 10, the client apparatus 30a displays the rough video content 14b on the display device of the client apparatus 30a (step S58), and has the user designate frames to be included in the digest. In the case where such designation is performed, the client apparatus 30a receives the designation input, and transmits the designated frame numbers (set of start and end) to the server 10 (step S59). The interface unit 15 of the server 10 receives the data of the frame numbers, and the data manager 13 generates the frame table 14c from the data of the frame numbers and stores it in the storage unit 14 (step S60).

The processing of the steps S51 to S60 is repeated, for example, until the frame table 14c of a predetermined number of N persons is acquired or for a predetermined period. Thereafter, at an arbitrary timing, the digest video data generator 16 or the data manager 13 generates the accumulated frame table 14d from the frame tables 14c, and stores it in the storage unit 14 (step S61).

Thereafter, the digest video data generator 16 generates the digest video data by a method described later on the basis of the accumulated frame table 14d (step S62), and stores the generated digest video data in the storage unit 14 (step S63).

By performing such processing, it becomes possible to automatically generate the digest efficiently without being affected by the subjectivity of a specific person such as a producer or an editor of the video. Incidentally, here, a check mechanism for checking the propriety of the generated digest video data by the side of the client apparatuses 30a to 30c may be provided. In this case, the obtained digest video data is transmitted to the client apparatus 30a, and a processing of accepting re-designation of frames has only to be included if necessary.

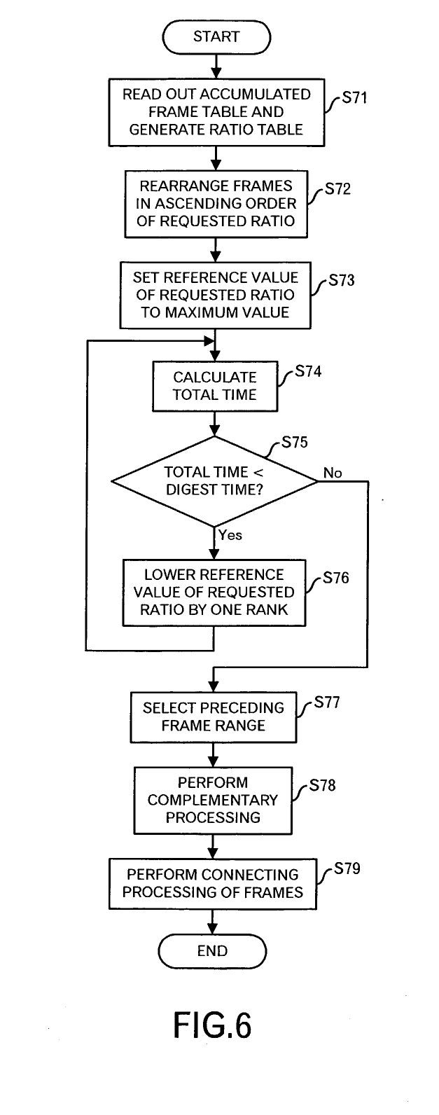

Next, a specific processing of generating the digest video data shown at the step S62 of FIG. 5 will be described by the use of FIG. 6. As shown in FIG. 6, the digest video data generator 16 first reads out the accumulated frame table 14d (step S71), generates a ratio table (for example, FIG. 3B) including the number of requesting persons and a requested ratio for each frame, and stores it in the storage device. Then, in the ratio table, records are rearranged in ascending order of requested ratio (step S72). Then, the digest video data generator 15 sets a reference value for the requested ratio to the maximum value of the requested ratio in the ratio table (step S73), and stores data of the range of frames having the requested ratio not less than the reference value into the storage device, and calculates the total time of the range of the frames (step S74).

Then, the digest video data generator 16 compares this total time with a previously set digest viewing time, and judges whether the total time is shorter than the digest viewing time (step S75). In case the total time is shorter than the digest viewing time (step S75: Yes route), after the reference value for the requested ratio is lowered by one rank (step S76), the processing proceeds to the step S74 and calculates the total time of the range of frames having the requested ratio not less than the reference value for the requested ratio.

Thereafter, a similar processing is repeated, and in the case where the total time becomes the digest viewing time or more (step S75: No route), the digest video data generator 16 selects the range of frames extracted with the reference value of the preceding requested ratio (step S77), and after a complementary processing is performed as the need arises (step S78), it performs a connecting processing of frames (step S79). Then, it stores the generated digest video data in the storage unit 14. Incidentally, the above complementary processing is such a processing that for example, in the case where only the frame 3 is missing from the frames 1 to 5 and the video becomes unnatural, this frame 3 is added.

Incidentally, although the total time of the range of frames is calculated at the step S74, and the selection of frames is performed on the basis of the requested ratio and the total time, the selection of frames may be performed on the basis of the requested ratio and the amount of data.

As described above, in this embodiment, the frame numbers of the re-viewing desired portions of the video content are collected from the users of the client apparatuses 30a to 30c, who viewed the video content provided by the server 10, to generate the frame table 14c, and on the basis of the accumulated frame table 14d and the ratio table collecting the frame tables of the respective users, the digest video data generator 16 generates the digest of the video content. Therefore, the digest of the video content can be automatically generated promptly and efficiently while the subjectivity of a specific person is excluded.

Incidentally, in this embodiment, although the digest is generated on the server 10, the invention is not limited to this, and a digest automatic generation apparatus can also be provided separately from the server 10.

Besides, in this embodiment, although the frames as the object of the digest are selected from the respective frames forming the video content, the object of the digest can also be selected in time units, not such frame extraction. Specifically, when the users specify the object of the digest on the client apparatuses 30a to 30c by the start time and the end time, the start time and the end time are stored in the frame table 14c.

Besides, in this embodiment, although the rough video content 14b is delivered from the server 10 to the respective client apparatuses 30a to 30c and the users are asked to select frames of the re-viewing desired portions, he or she may select frames of the re-viewing desired portions are selected from the original video content 14a, not the rough video content.

2. Second Embodiment

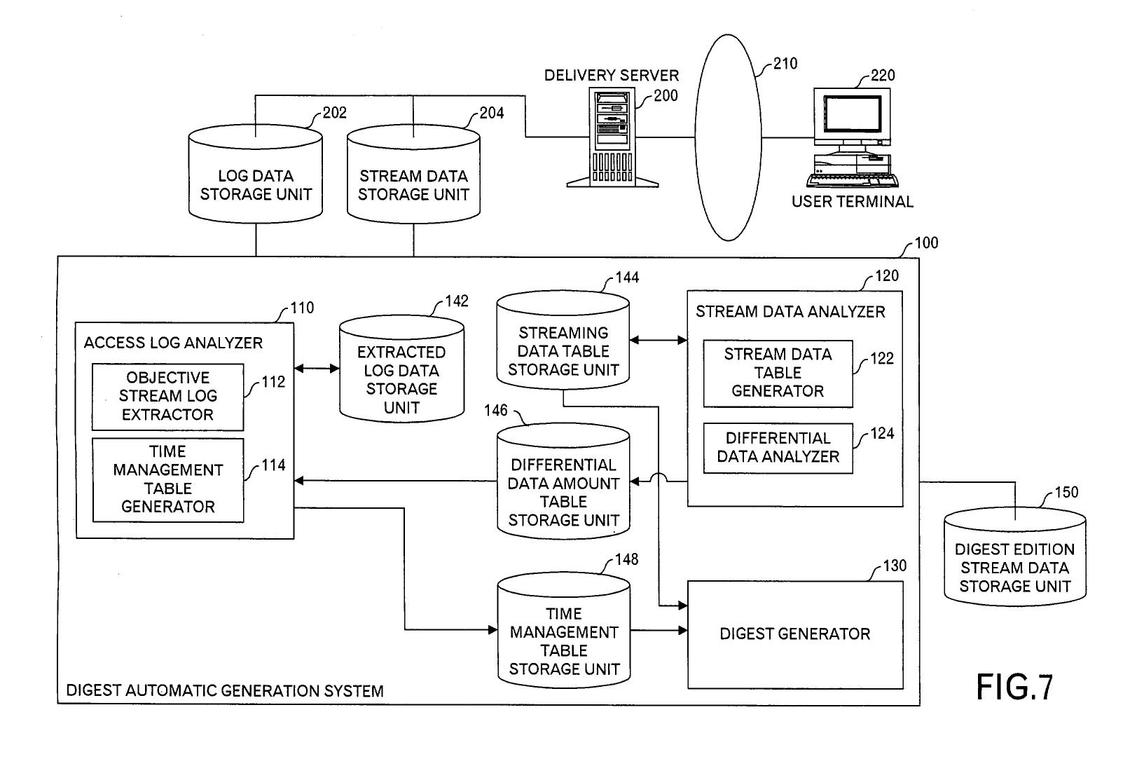

Next, a second embodiment of the invention will be described by the use of FIGS. 7 to 16. In the second embodiment, without having a user point out a re-viewing desired portion, on the basis of information concerning a content delivery state to a user terminal (which is also information concerning content delivery instructions from the user terminal), a digest of the content is generated. However, a portion in which the number of times of delivery (the number of reproduction instructions by the user, or the like) is large is not simply used for the digest, but a portion used for the digest is determined also in view of characteristics of the content. The characteristics of the content are mainly scene change or changeover, and in the streaming delivery, a judgment is made based on, for example, the change degree of the amount of delivered data per unit time. Hereinafter, the details of the second embodiment will be described.

FIG. 7 is a system outline diagram of the second embodiment. A delivery server 200 for performing streaming delivery of content data, and one or plural user terminals 220 for requesting the delivery server 200 to deliver content data and displaying the received content data on a display device are connected to a network 210, for example, the Internet. The delivery server 200 manages a stream data storage unit 204 for storing data of one or plural kinds of contents to be delivered by streaming, and a log data storage unit 202 for storing delivery log data of the content data stored in the stream data storage unit 204. Incidentally, not only the delivery log by the delivery server 200, but also data of delivery log by a cache server separately provided for streaming delivery of the content data are stored in the log data storage unit 202. As the content data stored in the stream data storage unit 204, in addition to data of content delivered on demand, data of content delivered live is also stored. The user terminal 220 can execute not only a Web browser but also a player consistent with the format of the content data delivered in streaming by the delivery server 200. Incidentally, since the configuration of the delivery server 200 and the user terminal 220 is not different from those of the background art, a further explanation is not made.

A digest automatic generation system 100 for carrying out a main processing of this embodiment carries out the processing by using the log data stored in the log data storage unit 202 and the content data stored in the stream data storage unit 204. The digest automatic generation system 100 includes an access log analyzer 110, a stream data analyzer 120, a digest generator 130, an extracted log data storage unit 142, a stream data table storage unit 144, a differential data amount table storage unit 146, and a time management table storage unit 148. Besides, the digest automatic generation system 100 manages a digest edition stream data storage unit 150 for storing the automatically generated digest. Incidentally, a system administrator separately makes settings as to whether or not the digest edition stream data stored in the digest edition stream data storage unit 150 is actually delivered from the delivery server 200.

The access log analyzer 110 includes an objective stream log extractor 112 for extracting the log data of the processing object from the log data storage unit 202 and storing it in the extracted log data storage unit 142, and a time management table generator 114 for generating a time management table by using the log data stored in the extracted log data storage unit 142 and the differential data amount table stored in the differential data amount table storage unit 146.

The stream data analyzer 120 includes a stream data table generator 122 for generating a stream data table from the content data of the processing object stored in the stream data storage unit 204 and storing it in the stream data table storage unit 144, and a differential data analyzer 124 for analyzing a change degree of an amount of data to be delivered (differential data amount) at predetermined intervals from the content data of the processing object stored in the stream data storage unit 204 and storing the analysis result in the differential data amount table storage unit 146.

The digest generator 130 carries out a processing of generating a digest by using the data stored in the stream data table storage unit 144, the data stored in the time management table storage unit 148, and the content data of the processing object stored in the stream data storage unit 204, and storing it in the digest stream data storage unit 150.

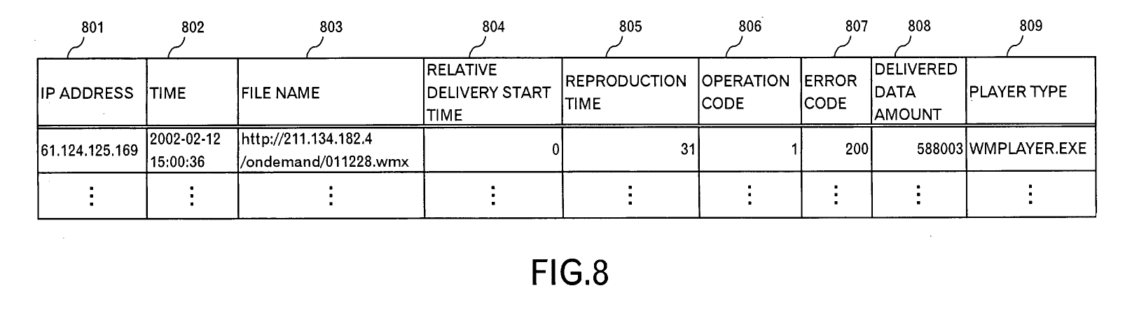

FIG. 8 shows an example of the log data stored in the log data storage unit 202. The example of the log data table shown in FIG. 8 includes a column 801 of an IP address of a delivery destination, a column 802 of a delivery start time, a column 803 of a file name of the delivered content, a column 804 of a relative delivery start time of the delivered data in the delivered content, a column 805 of a reproduction time from the relative delivery start time, a column 806 of an operation code, a column 807 of an error code, a column 808 of an amount of the delivered data, a column 809 of a player type used in the user terminal 220, and the like. The example of the first record of FIG. 8 indicates a delivery log in which reproduction (operation code=“1”) is performed for 31 seconds from the beginning (relative delivery start time=“0”) of the delivered content, and there is no error (error code=“200”). Incidentally, when the operation code is “5”, it is recorded that after fast-forward is carried out, reproduction is performed from the relative delivery start time stored in the column 804 of the relative delivery start time for the time stored in the column 805 of the reproduction time. Besides, when the operation code is “−5”, it is recorded that after rewinding is carried out, reproduction is performed from the relative delivery start time stored in the column 804 of the relative delivery start time for the time stored in the column 805 of the reproduction time. Incidentally, the error code “200” expresses success in processing, and “400” expresses failure in processing. Besides, here, although the one log data table is shown, there is also a case where it is divided into, for example, an access log data table and a user operation log data table.

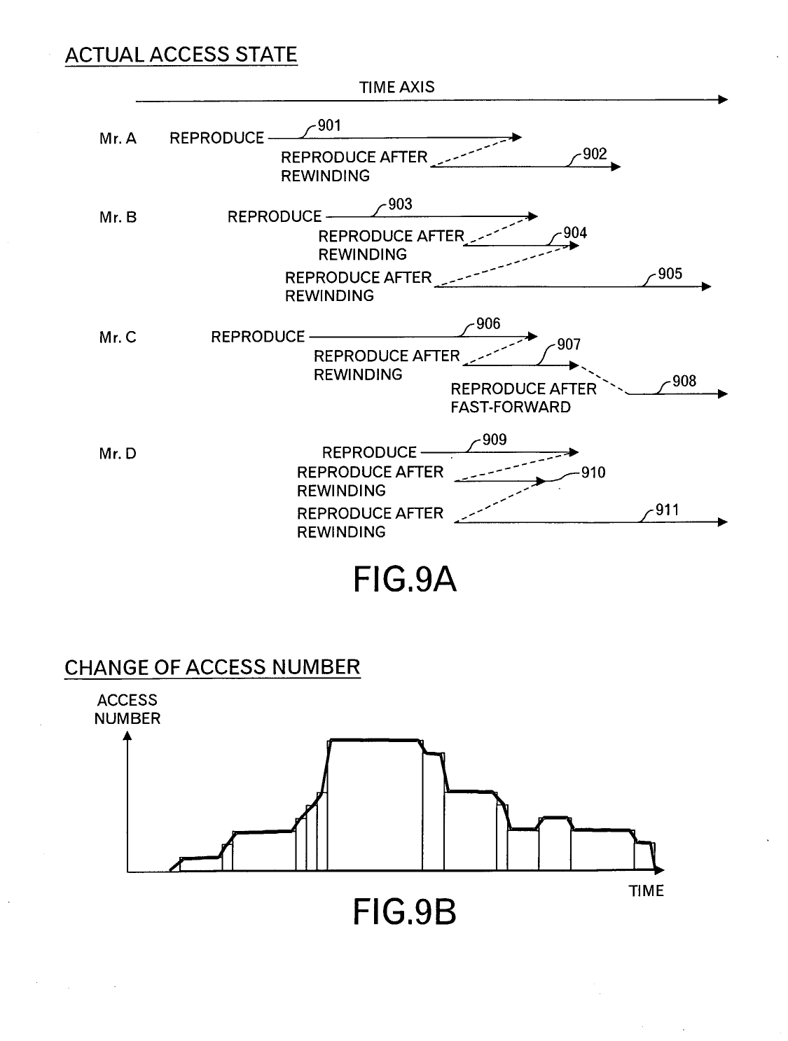

When such log data is prepared, it becomes possible to grasp an access state as shown in FIG. 9A. In the example of FIG. 9A, the log data of Mr. A is composed by a record which is generated when reproduction is first started and in which the operation code is “1”, and a record which is generated in the case where reproduction is performed after rewinding is performed and in which the operation code is “−5”. In FIG. 9A, they are denoted by arrows 901 and 902. The log data of Mr. B is composed by a record which is generated when reproduction is first performed and in which the operation code is “1”, a record which is generated in the case where reproduction is performed after first rewinding is performed and in which the operation code is “−5”, and a record which is generated in the case where reproduction is performed after second rewinding is performed and in which the operation code is “−5”. In FIG. 9A, they are denoted by arrows 903 to 905. The log data of Mr. C is composed by a record which is generated when reproduction is first performed and in which the operation code is “1”, a record which is generated in the case where reproduction is performed after rewinding is performed and in which the operation code is “−5”, and a record which is generated in the case where reproduction is performed after fast-forward is performed and in which the operation code is “5”. In FIG. 9A, they are denoted by arrows 906 to 908. The log data of Mr. D is composed by a record which is generated when reproduction is first performed and in which the operation code is “1”, a record which is generated in the case where reproduction is performed after first rewinding is performed and in which the operation code is “−5”, and a record which is generated in the case where reproduction is performed after second rewinding is performed and in which the operation code is “−5”. In FIG. 9A, they are denoted by arrows 909 to 911.

In the case where the access state as in FIG. 9A is stored as the log data, the time change of the number of accesses becomes as shown in FIG. 9B. In this embodiment, although only the number of accesses is not necessarily a standard of adoption to a digest, as shown in FIG. 9B, since a portion in which the number of accesses is large is a portion attracting many viewers, it is suitable as the standard of adoption to the digest.

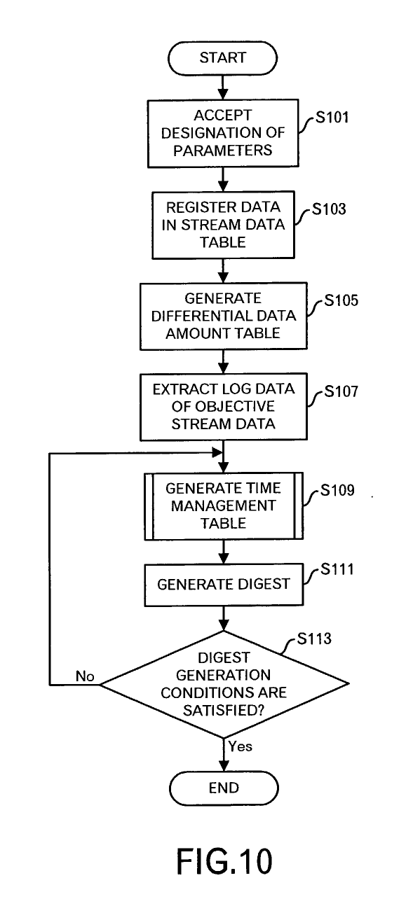

A processing flow of the digest automatic generation system 100 and its relevant data will be described by the use of FIGS. 10 to 16. First, the stream data analyzer 120 receives designation of various parameters by the person who causes the digest automatic generation system 100 to generate a digest, and stores them in the storage device (FIG. 10: step S101). For example, a file name (for example, http://211.134.182.4/sample.rm) of a stream data file, a stream information name (for example, “sample video”), a delivery date (in a live case), a differential data extraction time interval (for example, 20 seconds), a counting interval (for example, 10 seconds) of the number of accesses etc., a digest generation method, a designated delivery time (for example, 180 seconds) of a digest, and a designated file size (for example, 500 k bytes) of the digest are designated. Incidentally, the digest generation method includes designation of the operation code (for example, “1” is set in the case where designation concerning the number of accesses is performed, “2” is set in the case where designation of the number of times of rewinding is performed, “3” is set in the case where designation concerning an increasing number in the number of accesses is performed, and “4” is set in the case where designation concerning the number of pauses is performed), a reference count (for example, 100 times) for the designated operation code, designation as to which differential data among audio, video, and audio and video is made reference, and designation of a reference increase ratio of the differential data. The reference increase ratio of the differential data is designated by, for example, a numerical value such as 300%, and in case of 300%, a time when the differential data amount becomes four times as large as that at the last time is detected. Besides, although there is also a case where the designation for the operation code is an arbitrary combination of respective operations (including AND or OR), here, for simplification of explanation, only a case of singleness will be described. Incidentally, it is preferable that the counting interval is shorter than the differential data extraction time interval.

Next, the stream data table generator 122 of the stream data analyzer 120 refers to the stream data storage unit 204, reads out the stream data (content data) of the file name designated at the step S101, and acquires the information of the delivery time and the information of the total file size. Besides, the stream data information is registered in the stream data table by using the information of the delivery time and the information of the total file size, and the various parameters designated at the step S101 (step S103). The generated stream data table is stored in the stream data table storage unit 144.

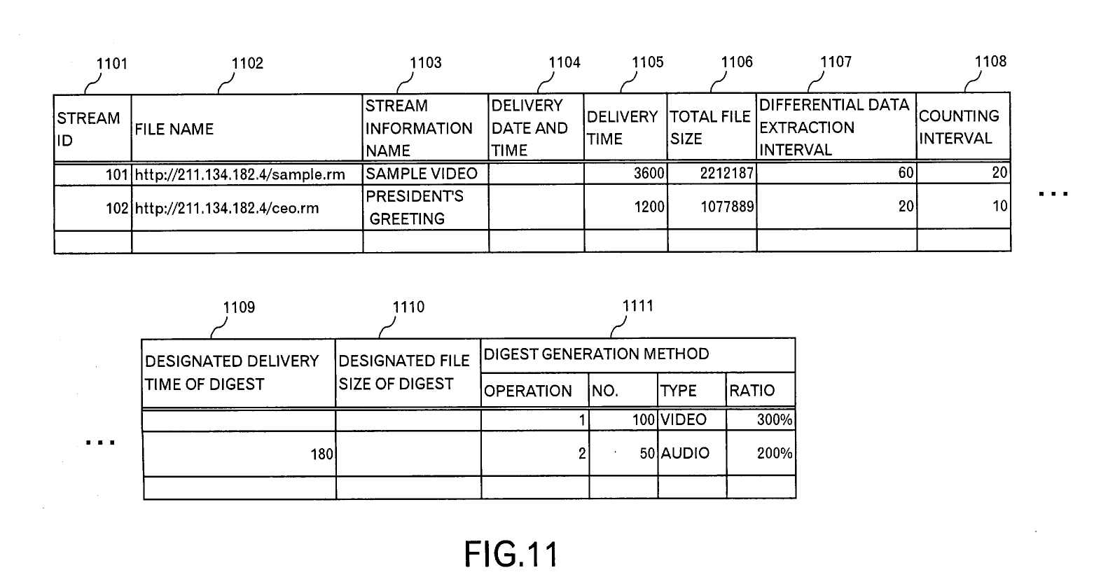

For example, a stream data table as shown in FIG. 11 is generated. The example of the stream data table shown in FIG. 11 includes a column 1101 of a stream ID to which the system sets the stream data uniquely for each file, a column 1102 of a file name, a column 1103 of a stream information name, a column 1104 of a delivery date, a column 1105 of a delivery time, a column 1106 of a total file size, a column 1107 of a differential data extraction time interval, a column 1108 of a counting interval, a column 1109 of a designated delivery time of a digest, a column 1110 of a designated file size of the digest, and a column 1111 of a digest generation method. The column 1111 of the digest generation method includes a column of a designated operation method (operation code), a column of a reference count for the designation operation method, a column of a reference type, and a column of a reference ratio.

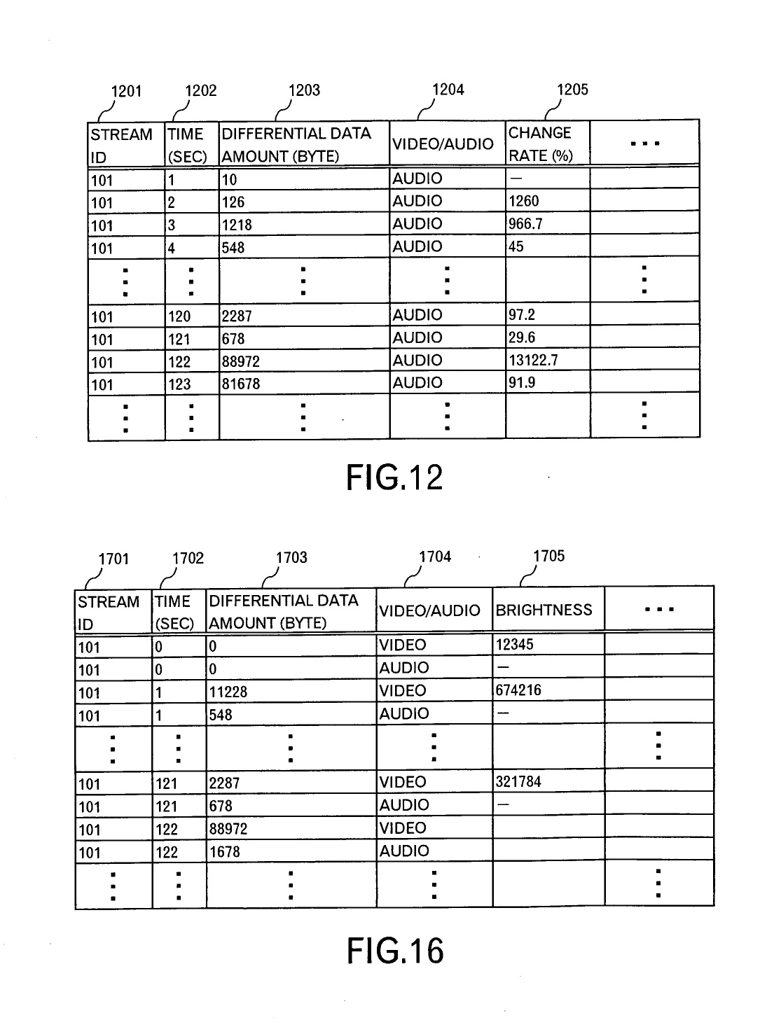

Next, the differential data analyzer 124 of the stream data analyzer 120 refers to the stream data storage unit 204, reads out the stream data of the file name designated at the step S101, calculates the differential data amount and the change rate at differential data extraction time intervals designated at the step S101, and stores them as a differential data amount table in the differential data amount table storage unit 146 (step S105). FIG. 12 shows an example of the differential data amount table. The example of the differential data amount table shown in FIG. 12 includes a column 1201 of a stream ID, a column 1202 of a relative start time of a differential data extraction time interval, a column 1203 of a differential data amount between an amount of data delivered in the former differential data extraction time interval and an amount of data delivered in this differential data extraction time interval, a column 1204 for indicating which of audio, video, and audio and video the differential data relates to, and a column 1205 of a change rate. This embodiment is premised on the stream delivery, and the streaming delivery is constructed such that only the differential data with respect to the former frame is delivered to the user terminal. Accordingly, in the case where the same image is displayed, the differential data does not exist, and in the case where a scene is changed over, a large amount of data must be delivered. Here, the differential data amount or the change rate is used in order to detect the changeover of the scene. Incidentally, the shorter the differential data extraction time interval is, the higher the detection accuracy of the changeover of the scene becomes, however, the processing time at the step S105 is also prolonged.

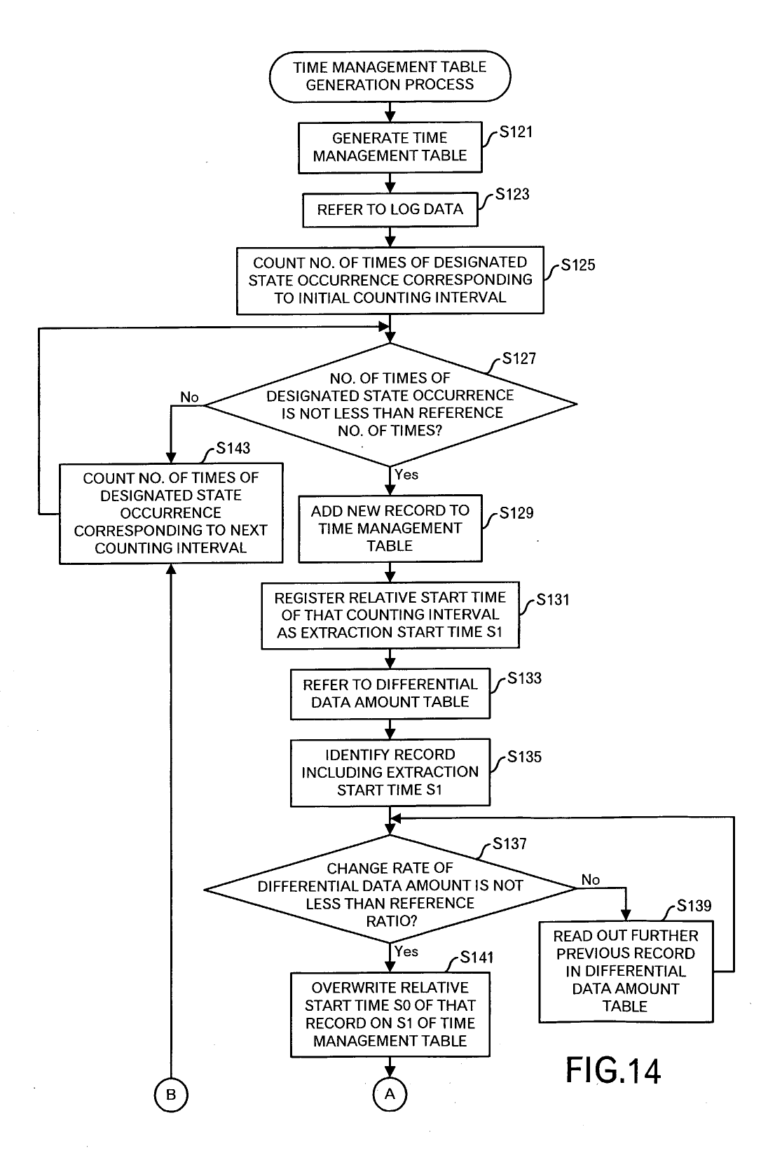

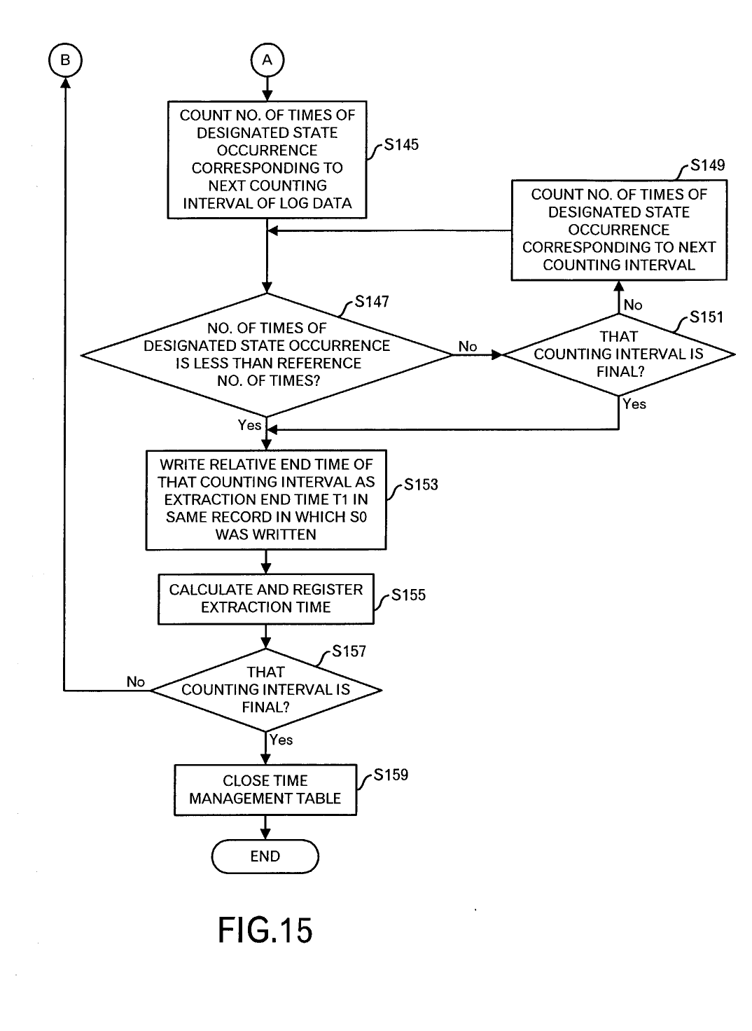

Besides, the objective stream log extractor 112 of the access log analyzer 110 extracts the log data for the file name designated at the step S101 from the log data storage unit 202, and stores it in the extracted log data storage unit 142 (step S107). Then, the time management table generator 114 of the access log analyzer 110 uses the log data stored in the extracted log data storage unit 142 and the data stored in the differential data amount table storage unit 146 to generate a time management table, and stores it in the time management table storage unit 148 (step S109). Incidentally, the details of this processing will be described later by the use of FIGS. 14 and 15. Incidentally, the time management table stores data concerning a time interval in the stream data, consistent with conditions designated at the step S101 (conditions specified by the designation for the operation code, the reference count for the designated operation code, the designation as to which of differential data of audio, video, and audio and video is made the reference, and the designation of the reference increase ratio of the differential data).

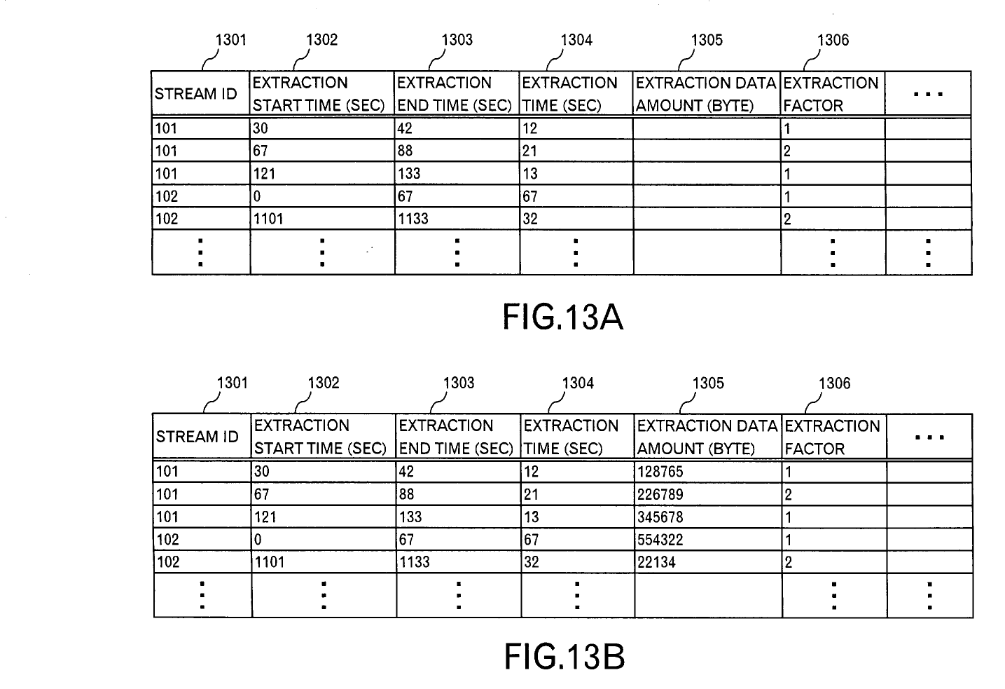

An example of the time management table is shown in FIG. 13A. The time interval table shown in FIG. 13A includes a column 1301 of a stream ID, a column 1302 of an extraction start time (relative time) a column 1303 of an extraction end time (relative time), a column 1304 of an extraction time, a column 1305 of an extraction data amount, and a column 1306 of an extraction factor. In the column 1306 of the extraction factor, for example, the same code as the designation for the operation code is registered, for example, in a form such as “1” in the case of extraction with the number of accesses, and “2” in the case of extraction with the number of times for rewinding.

Then, the digest generator 130 uses the data stored in the stream data storage unit 204 to generate a digest (digest edition stream data) so that the video, audio, or video and audio to be reproduced are included in all extraction time intervals registered in the time management table stored in the time management table storage unit 148, and stores the digest edition stream data in the digest edition stream data storage unit 150 (step S111). Then, the digest generator 130 judges whether the digest edition stream data generated at the step S111 satisfies digest generation conditions (designated delivery time of the digest, designated file size of the digest, or both) (step S113). In the case where the digest generation conditions are not set, or the digest generation conditions are satisfied (step S113: Yes route), the processing is ended. On the other hand, in the case where the digest generation conditions are not satisfied (step S113: No route), the processing is returned to the step S109, and the time management table is generated under new conditions (for example, the reference count for the designated operation code is increased by the predetermined rate or predetermined number).

By carrying out such processing, the digest of the content not affected by the subjectivity of a specific person and attracting the interest of many viewers can be automatically generated. Incidentally, the automatically generated digest is not adopted as it is, but one subjected to the review and adjustment of the person in charge may be opened to the viewers. Besides, in the case where only the condition for the designated delivering time of the digest is set, the digest edition stream data is not generated at the step S111, and at the stage where the time management table is generated at the step S109, it is also possible to judge whether or not the condition is satisfied.

Next, the details of the processing of generating the time management table at the step S109 will be described by the use of FIG. 14 and FIG. 15. First, the time management table generator 114 generates an empty time management table and stores it in the storage device (step S121). Then, it refers to all log data stored in the extracted log data storage unit 142 (step S123), counts the number of times of designated state occurrence corresponding to the first counting interval, and stores it in the storage device (step S125). The number of times of designated state occurrence is, for example, the number of times of the state occurrence specified by the operation code designated at the step S101, and is the number of accesses, the increasing number in the number of accesses, the number of times of rewinding, the number of times of pause, or the like. Then, the time management table generator 114 judges whether the number of times of designated state occurrence becomes not less than the reference count designated at the step S101 (step S127). In the case where the number of times of designated state occurrence is less than the reference count (step S127: No route), it counts the number of times of designated state occurrence corresponding to a next counting interval, and stores the number of times in the storage device (step S143). Then, the processing is returned to the step S127.

Incidentally, since there can be a case where the number of times of designated state occurrence does not once reach the reference count, in that case, it is necessary to output an error to change the reference count.

In the case where the number of times of designated state occurrence is not less than the reference count (step S127: Yes route), the time management table generator 114 adds a new record to the time management table (step S129), and registers the relative start time of the counting interval as an extraction start time S1 (step S131). At this point, the tentative start time is specified.

Then, the time management table generator 114 refers to the differential data amount table stored in the differential data amount table storage unit 146 (step S133), identifies the record including the extraction start time S1 in the differential data amount table, and stores it in the storage device (step S135). Thereafter, it judges whether or not the change rate of the differential data amount in the identified record is not less than the reference ratio set at the step S101 (step S137). When the change rate of the differential data amount in the identified record is less than the reference ratio (step S137: No route), it reads out a further previous record in the differential data amount table (step S139). Then, the processing is returned to the step S137. On the other hand, in a case where the change rate of the differential data amount is not less than the reference ratio (step S137: Yes route), it overwrites a relative start time S0 of the identified record on the extraction start time S1 of the time management table (step S141). By this, the relative start time of a portion to be adopted in the digest is corrected to the changeover time of the preceding scene. Then, the processing proceeds to a processing of FIG. 15 through terminal A.

In FIG. 15, the processing of specifying the extraction end time is carried out. First, the time management table generator 114 counts the number of times of designated state occurrence corresponding to a next counting interval of the log data, and stores it in the storage device (step S145). Although the processing is similar to the step S143, the number of times of occurrence for a state different from the step S143 may be counted. Then, it judges whether or not the number of times of designated state occurrence is less than the reference count (step S147). For example, it judges whether or not the number of accesses, the increasing number in the number of accesses, the number of times of rewinding, the number of times of pause, or the like becomes less than the reference count. Incidentally, although the reference count may be the same as the reference count at the step S127, a different number may be made the reference. If the number of times of designated state occurrence is not less than the reference count (step S147: No route), it judges whether the counting interval is the final counting interval (step S151). In the case where the counting interval is not the final counting interval (step S151: No route), it counts the number of times of designated state occurrence corresponding to the next counting interval and stores it in the storage device (step S149). Then, the processing proceeds to step S147. On the other hand, at the step S151, if it is judged that the counting interval is the final counting interval, the processing proceeds to step S153. Besides, at the step S147, also in the case where it is judged that the number of times of designated state occurrence is less than the reference count, the processing proceeds to the step S153.

Then, the management table generator 114 writes the relative end time of the counting interval as an extraction end time T1 in the same record in which S0 was written (step S153). Since the extraction start time and the extraction end time are specified in this way, it calculates the extraction time, and writes it in the same record in which S0 was written (step S155). Incidentally, here, an extraction factor of the record of the time management table may be registered. Besides, at this stage, the extraction data amount for this record of the time management table may be calculated and registered. In the case of registration, as shown in FIG. 13B, numerical values are registered in the column 1305 of the extraction data amount. However, in the case of streaming delivery, even in the case where the extraction start time and the extraction end time are specified, there is also a case where the extraction data amount can not be simply calculated. Thus, for example, at the stage of the step S111 of FIG. 10, the extraction data amount of each record may be registered in the time management table.

Thereafter, the time management table generator 114 judges whether the counting interval is the final counting interval (step S157). In the case where the counting interval is not the final counting interval (step S157: No route), the processing is returned to the step S143 through terminal B. In the case where the counting interval is the final counting interval (step S157: Yes route), the time management table is closed (step S159).

By carrying out such processing, the portion of content to be adopted in the digest can be extracted. Especially, the relative start time of the portion to be adopted becomes the changeover time of the scene, and a feeling of wrongness for a person viewing the digest lessens.

In the embodiment as described above, although the feature of the streaming delivery is used to specify the changeover of the scene by the change degree of differential data amount, another method may be used as the method of specifying the changeover of the scene. For example, an average value of brightness or color saturation of respective frames at the differential data extraction time intervals may be calculated and may be registered as a form shown in FIG. 16, and the changeover of the scene may be detected by using the change rate of the aforementioned differential data amount and/or the average value of the brightness or color saturation or the change rate of the average value. By this, it becomes possible to distinguish between changeover of a camera and a large change of a video image. The example of FIG. 16 includes a column 1701 of a stream ID, a column 1702 of a time, a column 1703 of a differential data amount, a column 1704 for indicating video, audio, or video and audio, and a column 1705 of brightness. With respect to the audio, since the brightness or color saturation do not exist, in the case where the audio is designated, the registration of brightness is not made. In the case where the table as shown in FIG. 16 is used, the condition of the step S137 of FIG. 14 has only to be changed. For example, the condition that the change amount of the average value of brightness is not less than XX is used.

Up to now, although the second embodiment of the invention has been described, the invention is not limited to this. That is, the function block diagram shown in FIG. 7 is merely an example, and the respective functional blocks do not necessarily correspond to modules of a program. Besides, the structure of the table is also an example, and there is also a case where other data are stored. There is also a case where the digest automatic generation system 100 is constituted by one computer or plural computers. Besides, there is also a case where the delivery server 200 operates as the digest automatic generation system 100.

Besides, in addition to one kind of content (stream data), two or more kinds of content may be handled as one kind of content and the aforementioned processing may be carried out. For example, a digest of several baseball games can be generated.

Besides, there is also a case where the first embodiment and the second embodiment are combined with each other. For example, an extracted portion for a digest may be initially specified by the configuration shown in the first embodiment, and the extracted portion for the digest may be changed by using information of a changeover portion of a scene as in the second embodiment. Particularly, the relative start time of the extracted portion for the digest may be initially specified by the configuration described in the first embodiment, and the relative start time may be changed by using the information of the changeover portion of the scene as in the second embodiment.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A digest automatic generation method for automatically generating a digest of a content to be delivered to a user terminal from a server, comprising the steps of:
acquiring user instruction information associated with a specific content from said user terminal that is a delivery destinations of said specific content; and
generating a digest of said specific content based on at least said user instruction information.

2. The digest automatic generation method as set forth in claim 1, wherein said user instruction information is information concerning a re-viewing desired range instructed by a user of said user terminal.

3. The digest automatic generation method as set forth in claim 2, wherein said acquiring step comprises the steps of:
transmitting content data having quality lower than said specific content to said user terminal; and
receiving information concerning said re-viewing desired range from said user terminal.

4. The digest automatic generation method as set forth in claim 2, wherein said digest generating step comprises the steps of:
by using said information concerning said re-viewing desired ranges from a plurality of users, summing up said re-viewing desired ranges by said plurality of users;
specifying a range constituting said digest of said specific content based on a summing result in said summing step; and
generating said digest including at least said range constituting said digest.

5. The digest automatic generation method as set forth in claim 4, wherein in said specifying step, said range constituting said digest of said specific content is limited based on a previously set limitation concerning a reproduction time or an amount of data of said digest.

6. The digest automatic generation method as set forth in claim 1, wherein said user instruction information is information concerning a delivery request for said specific content.

7. The digest automatic generation method as set forth in claim 6, further comprising a step of acquiring information concerning a scene change of said specific content,
wherein in said digest generating step, said digest of said specific content is generated based on said information concerning said scene change and said information concerning said delivery request for said specific content.

8. The digest automatic generation method as set forth in claim 7, wherein said information concerning said scene change of said specific content is information representing a change degree of an amount of data delivered in a predetermined period.

9. The digest automatic generation method as set forth in claim 7, wherein in said digest generating step, said information concerning said delivery request for said specific content is used to specify a noticeable range of said specific content in a predetermined delivery state, and said information concerning said scene change of said specific content is used to change said specified noticeable range of said specific content.

10. The digest automatic generation method as set forth in claim 7, wherein said digest generating step comprises the steps of:
specifying a start point of said noticeable range of said specific content in a first delivery state by using said information concerning said delivery request for the specific content;
changing the specified start point of said noticeable range of said specific content by using said information concerning said scene change of said specific content; and
specifying an end point of said noticeable range of said specific content in a second delivery state by using said information concerning said delivery request for said specific content.

11. The digest automatic generation method as set forth in claim 8, wherein said information concerning said scene change of said specific content includes information representing a change degree of brightness or color saturation between predetermined frames.

12. The digest automatic generation method as set forth in claim 9, wherein said predetermined delivery state is a state set for at least one of reproduction, rewinding, fast-forward, and stop.

13. The digest automatic generation method as set forth in claim 10, wherein said first delivery state is a state in which reproduction is performed a predetermined number of times or more; and said second delivery state is a state in which reproduction is performed less than a second predetermined number of times.

14. The digest automatic generation method as set forth in claim 9, wherein said digest generating step comprises a step of correcting said noticeable range of said specific content based on a previously set limitation on a reproduction time of said digest or an amount of data.

15. A digest automatic generation method for automatically generating a digest of a content to be delivered to a user terminal from a server, comprising the steps of:
acquiring information concerning a delivery state of a specific content to a user terminal and information concerning characteristics of said specific content; and
generating a digest of said specific content based on said information concerning said delivery state of said specific content and said information concerning said characteristics of said specific content.

16. The digest automatic generation method as set forth in claim 15, wherein in said digest generating step, said information concerning said delivery state of said specific content is used to specify a noticeable range of said specific content in a predetermined delivery state, and information concerning a scene change, which is said information concerning said characteristics of said specific content, is used to change the specified noticeable range of said specific content.

17. The digest automatic generation method as set forth in claim 16, wherein said digest generating step comprises the steps of:
specifying a start point of said noticeable range of said specific content in a first delivery state by using said information concerning said delivery state of said specific content;
changing said specified start point of said noticeable range of said specific content by using information concerning a point where a change of an amount of data delivered in a predetermined period exceeds a predetermined reference, said information concerning said point being said information concerning said characteristics of said specific content; and
specifying an end point of said noticeable range of said specific content in a second delivery state by using said information concerning said delivery state of said specific content.

18. The digest automatic generation method as set forth in claim 15, wherein said information concerning said characteristics of said specific content includes information representing a change degree of brightness or color saturation between predetermined frames.

19. The digest automatic generation method as set forth in claim 16, wherein said digest generating step comprises a step of correcting said noticeable range of said specific content based on a previously set limitation concerning a reproduction time of said digest or an amount of data.

20. A program embodied on a medium for causing a computer to automatically generate a digest of a content to be delivered to a user terminal from a server, said program comprising the steps of:
acquiring user instruction information associated with a specific content from said user terminal that is a delivery destinations of said specific content; and
generating a digest of said specific content based on at least said user instruction information.

21. The program as set forth in claim 20, wherein said user instruction information is information concerning a re-viewing desired range instructed by a user of said user terminal.

22. The program as set forth in claim 21, wherein said acquiring step comprises the steps of:
transmitting content data having quality lower than said specific content to said user terminal; and
receiving information concerning said re-viewing desired range from said user terminal.

23. The program as set forth in claim 21, wherein said digest generating step comprises the steps of:
by using said information concerning said re-viewing desired ranges from a plurality of users, summing up said re-viewing desired ranges by said plurality of users;
specifying a range constituting said digest of said specific content based on a summing result in said summing step; and
generating said digest including at least said range constituting said digest.

24. The program as set forth in claim 23, wherein in said specifying step, said range constituting said digest of said specific content is limited based on a previously set limitation concerning a reproduction time or an amount of data of said digest.

25. The program as set forth in claim 20, wherein said user instruction information is information concerning a delivery request for said specific content.

26. The program as set forth in claim 25, further comprising a step of acquiring information concerning a scene change of said specific content,
wherein in said digest generating step, said digest of said specific content is generated based on said information concerning said scene change and said information concerning said delivery request for said specific content.

27. The program as set forth in claim 26, wherein said information concerning said scene change of said specific content is information representing a change degree of an amount of data delivered in a predetermined period.

28. The program as set forth in claim 26, wherein in said digest generating step, said information concerning said delivery request for said specific content is used to specify a noticeable range of said specific content in a predetermined delivery state, and said information concerning said scene change of said specific content is used to change said specified noticeable range of said specific content.

29. The program as set forth in claim 26, wherein said digest generating step comprises the steps of:
specifying a start point of said noticeable range of said specific content in a first delivery state by using said information concerning said delivery request for the specific content;
changing the specified start point of said noticeable range of said specific content by using said information concerning said scene change of said specific content; and
specifying an end point of said noticeable range of said specific content in a second delivery state by using said information concerning said delivery request for said specific content.

30. The program as set forth in claim 27, wherein said information concerning said scene change of said specific content includes information representing a change degree of brightness or color saturation between predetermined frames.

31. The program as set forth in claim 28, wherein said predetermined delivery state is a state set for at least one of reproduction, rewinding, fast-forward, and stop.

32. The program as set forth in claim 29, wherein said first delivery state is a state in which reproduction is performed a predetermined number of times or more; and said second delivery state is a state in which reproduction is performed less than a second predetermined number of times.

33. The program as set forth in claim 28, wherein said digest generating step comprises a step of correcting said noticeable range of said specific content based on a previously set limitation on a reproduction time of said digest or an amount of data.

34. A program embodied on a medium for causing a computer to automatically generate a digest of a content to be delivered to a user terminal from a server, said program comprising the steps of:
acquiring information concerning a delivery state of a specific content to a user terminal and information concerning characteristics of said specific content; and
generating a digest of said specific content based on said information concerning said delivery state of said specific content and said information concerning said characteristics of said specific content.

35. The program as set forth in claim 34, wherein in said digest generating step, said information concerning said delivery state of said specific content is used to specify a noticeable range of said specific content in a predetermined delivery state, and information concerning a scene change, which is said information concerning said characteristics of said specific content is used to change the specified noticeable range of said specific content.

36. The program as set forth in claim 35, wherein said digest generating step comprises the steps of:
specifying a start point of said noticeable range of said specific content in a first delivery state by using said information concerning said delivery state of said specific content;
changing said specified start point of said noticeable range of said specific content by using information concerning a point where a change of an amount of data delivered in a predetermined period exceeds a predetermined reference, said information concerning said point being said information concerning said characteristics of said specific content; and
specifying an end point of said noticeable range of said specific content in a second delivery state by using said information concerning said delivery state of said specific content.

37. The program as set forth in claim 34, wherein said information concerning said characteristics of said specific content includes information representing a change degree of brightness or color saturation between predetermined frames.

38. The program as set forth in claim 35, wherein said digest generating step comprises a step of correcting said noticeable range of said specific content based on a previously set limitation concerning a reproduction time of said digest or an amount of data.

39. A digest automatic generation apparatus for automatically generating a digest of a content to be delivered to a user terminal from a server, comprising:
means for acquiring user instruction information associated with a specific content from said user terminal that is a delivery destinations of said specific content; and
means for generating a digest of said specific content based on at least said user instruction information.

40. The digest automatic generation apparatus as set forth in claim 39, wherein said user instruction information is information concerning a re-viewing desired range instructed by a user of said user terminal.

41. The digest automatic generation apparatus as set forth in claim 40, wherein said means for acquiring comprises:
means for transmitting content data having quality lower than said specific content to said user terminal; and
means for receiving information concerning said re-viewing desired range from said user terminal.

42. The digest automatic generation apparatus as set forth in claim 40, wherein said means for generating the digest comprises:
means for summing up said re-viewing desired ranges by a plurality of users by using said information concerning said re-viewing desired ranges from said plurality of users;
means for specifying a range constituting said digest of said specific content based on a summing result by said means for summing; and
means for generating said digest including at least said range constituting said digest.

43. The digest automatic generation apparatus as set forth in claim 42, wherein said means for specifying limits said range constituting said digest of said specific content based on a previously set limitation concerning a reproduction time or an amount of data of said digest.

44. The digest automatic generation apparatus as set forth in claim 39, wherein said user instruction information is information concerning a delivery request for said specific content.

45. The digest automatic generation apparatus as set forth in claim 44, further comprising means for acquiring information concerning a scene change of said specific content,
wherein said means for generating the digest generates said digest of said specific content based on said information concerning said scene change and said information concerning said delivery request for said specific content.

46. The digest automatic generation apparatus as set forth in claim 45, wherein said information concerning said scene change of said specific content is information representing a change degree of an amount of data delivered in a predetermined period.

47. The digest automatic generation apparatus as set forth in claim 45, wherein said means for generating said digest uses said information concerning said delivery request for said specific content to specify a noticeable range of said specific content in a predetermined delivery state, and uses said information concerning said scene change of said specific content to change said specified noticeable range of said specific content.

48. The digest automatic generation apparatus as set forth in claim 45, wherein said means for generating said digest comprises:
means for specifying a start point of said noticeable range of said specific content in a first delivery state by using said information concerning said delivery request for the specific content;
means for changing the specified start point of said noticeable range of said specific content by using said information concerning said scene change of said specific content; and
means for specifying an end point of said noticeable range of said specific content in a second delivery state by using said information concerning said delivery request for said specific content.

49. The digest automatic generation apparatus as set forth in claim 46, wherein said information concerning said scene change of said specific content includes information representing a change degree of brightness or color saturation between predetermined frames.

50. The digest automatic generation apparatus as set forth in claim 47, wherein said predetermined delivery state is a state set for at least one of reproduction, rewinding, fast-forward, and stop.

51. The digest automatic generation apparatus as set forth in claim 48, wherein said first delivery state is a state in which reproduction is performed a predetermined number of times or more; and said second delivery state is a state in which reproduction is performed less than a second predetermined number of times.

52. The digest automatic generation apparatus as set forth in claim 47, wherein said means for generating said digest comprises means for correcting said noticeable range of said specific content based on a previously set limitation on a reproduction time of said digest or an amount of data.

53. A digest automatic generation apparatus for automatically generating a digest of a content to be delivered to a user terminal from a server, comprising:
means for acquiring information concerning a delivery state of a specific content to a user terminal and information concerning characteristics of said specific content; and
means for generating a digest of said specific content based on said information concerning said delivery state of said specific content and said information concerning said characteristics of said specific content.

54. The digest automatic generation apparatus as set forth in claim 53, wherein said means for generating said digest uses said information concerning said delivery state of said specific content to specify a noticeable range of said specific content in a predetermined delivery state, and uses information concerning a scene change, which is said information concerning said characteristics of said specific content, to change the specified noticeable range of said specific content.

55. The digest automatic generation apparatus as set forth in claim 54, wherein said means for generating said digest comprises:
means for specifying a start point of said noticeable range of said specific content in a first delivery state by using said information concerning said delivery state of said specific content;
means for changing said specified start point of said noticeable range of said specific content by using information concerning a point where a change of an amount of data delivered in a predetermined period exceeds a predetermined reference, said information concerning said point being said information concerning said characteristics of said specific content; and
means for specifying an end point of said noticeable range of said specific content in a second delivery state by using said information concerning said delivery state of said specific content.

56. The digest automatic generation apparatus as set forth in claim 54, wherein said information concerning said characteristics of said specific content includes information representing a change degree of brightness or color saturation between predetermined frames.

57. The digest automatic generation apparatus as set forth in claim 54, wherein said means for generating said digest comprises means for correcting said noticeable range of said specific content based on a previously set limitation concerning a reproduction time of said digest or an amount of data.
